(19) United States
(12) Patent Application Publication
(10) Pub. No.: US 2015/0224518 A1
(43) Pub. Date: Aug. 13, 2015

(54) APPARATUS FOR INTERMITTENT LIQUID DISPERSAL

(71) Applicant: Q Industries LLC, Boulder, CO (US)

(72) Inventor: Quentin M. McKenna, Boulder, CO (US)

(73) Assignee: Q Industries LLC, Boulder, CO (US)

(21) Appl. No.: 14/175,836

(22) Filed: Feb. 7, 2014

(51) Int. Cl. B05B 1/08; F16K 31/08

(52) U.S. Cl. CPC B05B 1/083; F16K 31/084

(57) ABSTRACT

Valve for the periodic and cyclic or otherwise intermittent release of a fluid is described along with an irrigation sprinkler incorporating the valve. The valve opens when a critical pressure level is reached in a reservoir attached to the valve, thereby permitting a portion of the fluid contained within the reservoir to be released through the valve. As the fluid is released, the pressure in the reservoir decreases. The valve does not close until the pressure level in the reservoir reaches a second pressure level that is below the critical pressure level. When the reservoir is refilled from a pressurized source at a controlled rate that is less the rate at which the fluid is expelled through the valve when open, the valve will cycle repetitively.

### CROSS REFERENCE TO RELATED APPLICATION

This application is related to U.S. patent application Ser. No. 10/824,171, entitled “Apparatus for Intermittent Liquid Dispersal” filed on Apr. 13, 2004 now U.S. Pat. No. 6,981,654, which claims priority from U.S. patent application Ser. No. 09/885,378, entitled “Apparatus for Intermittent Liquid Dispersal” filed on Jun. 19, 2001 now U.S. Pat. No. 6,732,947, which claims priority from U.S. Provisional Patent Application No. 60/212,896, entitled “Apparatus for Periodic Liquid Dispersal” filed on Jun. 20, 2000; the disclosures of each of these applications are hereby incorporated by reference herein.

### TECHNICAL FIELD

The disclosure herein relates generally to intermittent liquid dispersal and more particularly to intermittent liquid dispersal for irrigation and pest control.

### BACKGROUND

A wide variety of irrigation systems are commercially available for use in watering crops, plants, and lawns. Sprinkler-based systems are generally the most popular, although systems that deposit water directly on the ground are also utilized, such as drip systems. In either case these systems are often automated so that they irrigate an associated area on a periodic basis without substantial human intervention.

Automated systems typically comprise an electronic controller and solenoid valve electrically coupled to the controller. The solenoid valve is typically located inline with a pressurized source of water. In operation, the valve opens to allow water to flow from the source, through a conduit, and out one or more sprinkler heads or drip emitters. When the cycle is complete, the controller signals the solenoid valve to close. Typically, these systems operate no more than a few times in day. A typical watering cycle may last anywhere from a few minutes to more than an hour.

After a watering cycle has been completed, it is not uncommon for the ground to be soaked and saturated. In the intervening period between cycles, the soil can become arid, especially in hot and dry climates. Both saturated and arid ground conditions can be damaging to certain types of plants. For instance, a seedling without a developed root system can be dislodged from the soil if enough water is added to the ground to cause puddling. Additionally, if the ground around a seedling is allowed to dry completely for even a short period of time the seedling can quickly dehydrate and die. Furthermore, there are types of plants that have root systems that are very intolerant of saturated soil conditions and can be damaged if exposed to saturated soil on a regular basis.

Ideally, it would be desirable to maintain soil at a predetermined and constant moisture level that is ideal for the plants growing therein. Increasing the frequency of irrigation cycles while reducing the time there between helps to maintain the soil at a more constant moisture level, but most electronic controllers are designed only to open an associated solenoid at most a few times every day. Even if controllers were available that allowed frequent watering cycles of short duration, the electronic solenoids generally available for use in sprinkler systems are not designed for continuous repetitive duty.

Another drawback of electronic systems is that they require coupling to an electrical power source that may not be conveniently available. Additionally, the conduits of electrical current, such as the wires between the solenoid and the controller, must be protected from moisture and other potential sources of damage. These requirements of traditional automatic systems make them complicated and consequently difficult and expensive to install. Another problem that traditionally affects farmers and home gardeners alike is damage done to plants and crops by animals. It can be appreciated that animals in general will not bother plants or crops while a sprinkler is in operation because either they do not like the water or they are scared by sprinkler noise. Traditional sprinklers are relatively effective in deterring animals from entering an area being irrigated. Unfortunately, traditional sprinklers cannot be left on continuously for extended periods of time because of the amount of water used and the potential saturation of the underlying soil. Other objects, such as scarecrows, have very little effect on most animals. There are solutions that can be applied to the surfaces of plants that make them undesirable to animals, although the nature of the solutions often preclude there use on crops that are to be consumed by humans.

### SUMMARY

According to the present disclosure there is, therefore, provided an intermittent liquid dispersal device as described in the specification and accompanying claims.

In an example of the present disclosure, a device for the intermittent dispersal of a fluid may include a housing with an inlet, to receive a fluid placed under increasing pressure. The housing may have an outlet to disperse the fluid. The housing may include a longitudinal bore extending through the housing and intersecting with a transverse bore forming the outlet. The longitudinal bore may have a first diameter and a second diameter in fluid communication with the inlet. The device may include a piston head at least partially contained within the longitudinal bore of the housing. The piston head may be movable (i) from a closed position to an open position when the fluid pressure equals or exceeds a first pressure level, and (ii) from an open position to a closed position when the pressure is less than or equal to a second pressure level. The second pressure level may be lower than the first pressure level. The piston head may include a first seal which obstructs the flow of the fluid from the inlet to the outlet in response to the piston head being in the closed position. The piston head may permit the flow of fluid from the inlet to the outlet in response to the piston head being in the open position. The first seal may contact the first bore diameter in the closed position. The first seal may move out of the first bore diameter in the open position.

In accordance with various embodiments, the first diameter of the longitudinal bore is smaller than the second diameter of the longitudinal bore. The piston head may further include a second seal in contact with the second diameter of the longitudinal bore. The second seal may maintain contact with the second diameter of the longitudinal bore in both the open position and closed position thereby obstructing fluid from flowing out of the longitudinal bore. The first seal may have less contact with the longitudinal bore in the open position than in the closed position thereby reducing friction between the first seal and the longitudinal bore in the open position.

In accordance with various embodiments, the first diameter of the longitudinal bore and the second diameter of the longitudinal bore may meet at a transition located between the inlet and the transverse bore. The transition may be a surface connecting a wall defining the first diameter of the longitudinal bore and a wall defining the second diameter of the longitudinal bore. The transition surface may be approximately 45 degrees from a plane perpendicular to the longitudinal bore.

In accordance with various embodiments, the first seal may be located within a first groove around the piston head with the first groove having a first diameter. The second seal may be located within a second groove around the piston head with the second groove having a second diameter. The second groove may be larger in diameter than the first groove thereby causing an outer circumference of the second seal to extend farther from the axis of the piston head than an outer circumference of the first seal. This difference in circumferences between seals may cause the second seal to have tighter fit in the second diameter of the longitudinal bore than the fit of the first seal.

In accordance with various embodiments, the device may include a valve stem connected to the piston head and extending out of the housing opposite the inlet and along the longitudinal bore. The valve stem may pass through a first magnet assembly and connect to a second magnet assembly such that the second magnet assembly moves in relation to the valve stem which in turn moves the piston head. The device may include a cap which attaches to a top portion of the housing located opposite the inlet. The first magnet assembly may be sandwiched between the cap and the housing. The attraction between the first magnet assembly and the second magnet assembly forms at least a portion of a retention force to hold the piston head in the closed position against the fluid under increasing pressure. The piston head may move toward the open position when the retention force is met. The device may include a reservoir in fluid communication with the inlet. The reservoir may be adapted to contain a compressible medium and to receive a fluid providing an increasing pressure in the reservoir. The reservoir may supply the fluid placed under increasing pressure received by the inlet. The compressible medium and the fluid may be separated by an expandable bladder 1114 which limits the fluid from absorbing the compressible medium. The reservoir may be a tank positioned vertically such that the bladder 1114 uniformly expands within the tank without being substantially biased in one direction due to gravity.

In an example of the present disclosure, a device for the intermittent dispersal of a fluid may include a housing with an inlet, to receive a fluid placed under increasing pressure. The device may have an outlet to disperse the fluid. The housing may include a longitudinal bore extending through the housing and intersecting a transverse bore forming the outlet. The device may include a piston head at least partially contained within the longitudinal bore of the housing. The piston head may be movable (i) from a closed position to an open position when the fluid pressure equals or exceeds a first pressure level, and (ii) from an open position to a closed position when the pressure is less than or equal to a second pressure level. The second pressure level may be lower than the first pressure level. The piston head may include a first seal and a second seal. The first seal may be seated more tightly in the longitudinal bore in response to the piston head being in the closed position than compared to the seating of the first seal in the longitudinal bore in response to the piston head being in the open position. The second seal may maintain substantially the same fit within the longitudinal bore regardless of whether the piston head is in the closed position or the open position.

In accordance with various embodiments, the longitudinal bore may include a first diameter and a second diameter with the first diameter being smaller than the second diameter. The first seal may obstruct the flow of the fluid from the inlet to the outlet in response to the piston head being in the closed position. The first seal may permit the flow of fluid from the inlet to the outlet in response to the piston being in the open position. The first seal may contact the first bore diameter in the closed position. The first seal may move out of the first bore diameter in the open position. The first seal may have less contact with the longitudinal bore in the open position than in the closed position. The piston head may include a second seal in contact with the second diameter of the longitudinal bore. The second seal may maintain contact with the second diameter of the longitudinal bore in both the open position and closed position thereby obstructing fluid from flowing out of the longitudinal bore.

In accordance with various embodiments, the first diameter of the longitudinal bore and the second diameter of the longitudinal bore may meet at a transition located between the inlet and the transverse bore. The transition may be a surface connecting a wall defining the first diameter of the longitudinal bore and a wall defining the second diameter of the longitudinal bore. The transition surface is approximately 45 degrees from a plane perpendicular to the longitudinal bore.

In accordance with various embodiments, the first seal may be located within a first groove around the piston head. The second seal may be located within a second groove around the piston head with the first groove having a first diameter and the second groove having a second diameter. The second groove may be larger in diameter than the first groove thereby causing an outer circumference of the second seal to extend farther from the axis of the piston head than an outer circumference of the first seal. This difference in outer circumference may cause the second seal to have tighter fit in the second diameter of the longitudinal bore than the fit of the first seal within the second diameter of the longitudinal bore.

This summary of the disclosure is given to aid understanding, and one of skill in the art will understand that each of the various aspects and features of the disclosure may advantageously be used separately in some instances, or in combination with other aspects and features of the disclosure in other instances.

### BRIEF DESCRIPTION OF THE DRAWINGS

The present disclosure will now be described by way of example only with reference to the following figures in which:

FIG. 1 is an isometric view of an embodiment of a pressure-activated magnetic valve.

FIG. 2 is an exploded isometric view of the embodiment of a pressure-activated magnetic valve illustrated in FIG. 1.

FIG. 3A is an isometric view of an embodiment of a valve housing.

FIG. 3B is a top view of an embodiment of a valve housing.

FIG. 4 is an isometric view of an embodiment of a valve stem.

FIG. 5 is an isometric view of an embodiment of a piston.

FIG. 6A is an isometric view of an embodiment of a magnet cap.

FIG. 6B is a top view of an embodiment of a magnet cap.

FIG. 7A is a cross-sectional view of the pressure-activated magnetic valve of FIG. 1 taken along line A-A illustrating the valve in the closed position.

FIG. 7B is a cross-sectional view of the pressure-activated magnetic valve of FIG. 1 taken along line A-A illustrating the valve in the open position.

FIG. 8 is a cross-sectional view of an embodiment of the reservoir of FIG. 1.

### DETAILED DESCRIPTION

The disclosure herein relates generally to intermittent liquid dispersal and more particularly to intermittent liquid dispersal for irrigation and pest control. The device includes a valve that is actuated by an actuation force (A) that is the result of a pressure buildup in the incoming fluid. The pressure buildup surpasses a retention force (R) created by two opposing magnetic assemblies, thereby causing the valve to open. This subject matter is related to U.S. Pat. No. 6,981,654 and U.S. Pat. No. 6,732,947, which are incorporated herein by reference. These patents may form a background and foundation to the disclosure discussed herein. The various aspects, embodiments, examples, structures, and configurations discussed herein may be applicable and/or interchangeable with the embodiments or disclosure presented in these related patents.

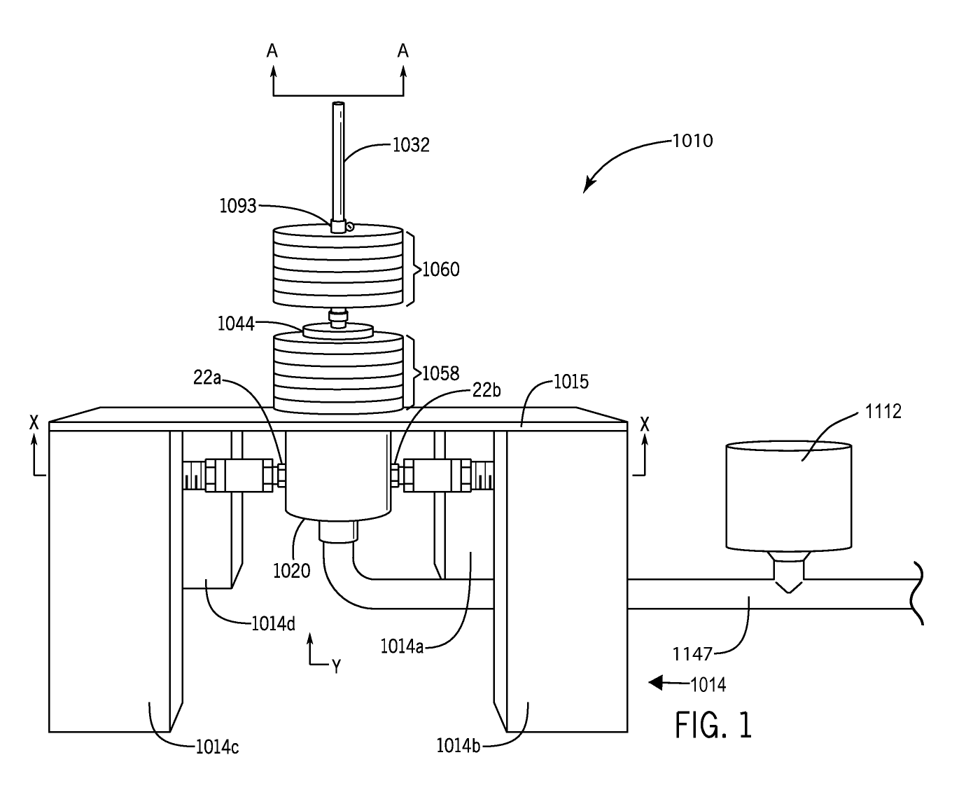

FIG. 1 illustrates a perspective view of a pressure-activated magnetic valve (“valve”) 1010. The valve 1010 is operable as an intermittent liquid emitter valve. The valve 1010 is supported by a base 1014. The base 1014 may be any support that is operable to suspend other components off the ground. For example, the base 1014 may suspend a mounting platform 1015. The base 1014 may form a wide support structure under the mounting platform 1015. A wide support structure may be operable to keep the mounting platform 1015 from tipping over due to pressure fluctuations in the attached flow channels discussed in more detail below. In one example, base 1014 may include a plurality of support columns 1014a-d. The support columns 1014a-d may be positioned around the perimeter of the mounting platform 1015.

The valve 1010 may also include a valve housing 1020. The platform 1015 may support and elevate valve housing 1020. For example, platform 1015 and support columns 1014a-d may elevate valve housing 1020 off the ground such that a fluid flow Y can enter the valve 1010 without significant interference from the ground or similar obstacles.

The valve housing 1020 may be connected to one or more fluid outlets. For example, a fluid outlet 1022a and a fluid outlet 1022b may exit the valve housing 1020 on radially opposing sides. The one or more fluid outlets may direct a fluid flow X out of the valve housing 1020 into fluid channels extending to a fluid dispersion system (e.g. a sprinkler system).

The valve 1010 may also include a valve stem 1032 which extends through the valve housing 1020. A first magnet assembly 1058 may be aligned over the valve stem 1032. The magnet assembly 1058 may be positioned between the platform 1014 and a cap 1044. A second magnet assembly 1060 may be positioned adjacent the first magnet assembly 1058. The second magnet assembly 1060 may also be positioned on the valve stem 1032. In various embodiments the second magnetic assembly 1060 may be fixed relative to the valve stem 1032 and the first magnetic assembly 1058 may be fixed relative to the valve housing 1020. For example, clamp 1093 may inhibit the second magnetic assembly 1060 from being removed from the valve stem 1032. The valve stem 1032 may be movable relative to the valve housing 1020. The first magnetic assembly 1058 and the second magnetic assembly 1060 may be positioned to provide a force between themselves which limits the movement of the valve stem 1032 from moving upwardly until the force between the two magnetic assemblies 1058,1060 is overcome.

The valve housing 1020 may be in fluid communication with a reservoir 1112 via the fluid line 1147. The fluid line 1147 may provide a fluid under increasing and decreasing pressure to the valve housing 1020 at the bottom portion 1026. The reservoir may be operable to provide the increase and decrease in pressures which actuates the valve.

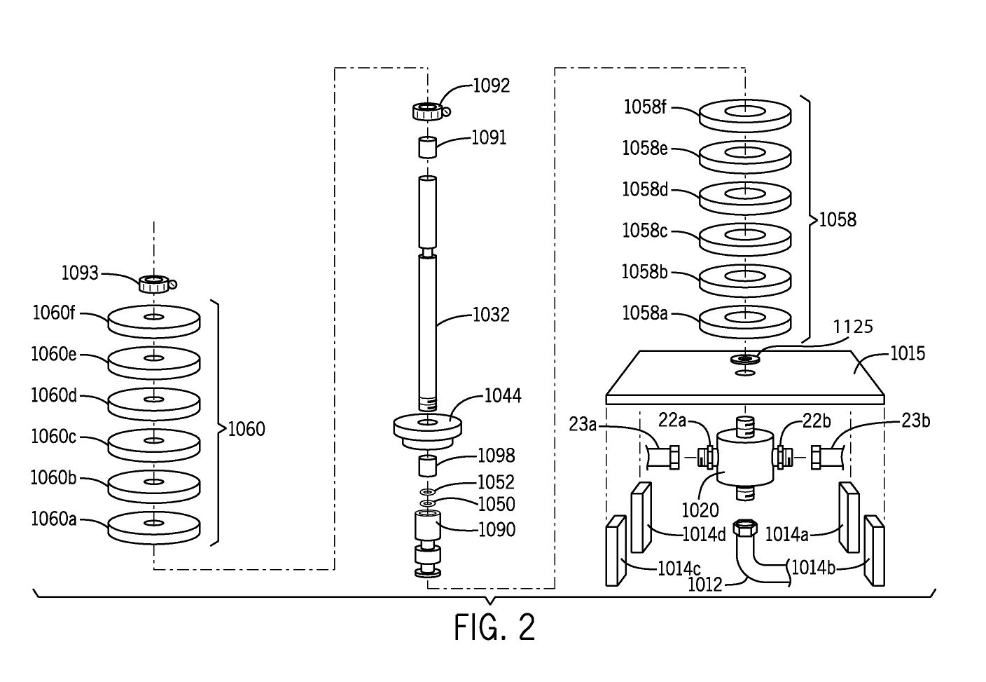

FIG. 2 is an exploded isometric view of the embodiment of a pressure-activated magnetic valve 1010 illustrated in FIG. 1. The valve 1010 may include the valve housing 1020. The valve housing 1020 may be connected to inlet channel 1012 and fittings 1022a,b. The valve housing 1020 may be mounted to platform 1015 which may be elevated by base supports 1014a-d. A locking threadable nut 1125 may be threaded onto the valve housing 1020. The nut 1125 may restrain the housing 1020 while assembling the magnetic assembly 1058 over the valve housing 1020. The nut 1125 may be position between the magnetic assembly 1058 and the valve housing 1020.

Fittings 1022a,b may be connected to liquid distribution channels 1023a,b. The valve stem 1032 by be located through valve housing 1020. A piston head 1090 may be located on the first end of the valve stem 1032. A first seal 1050 (e.g. an o-ring) may be located around the piston head 1090 in a first groove 1095. A seal 1052 may be located around the piston head 1090 in a second groove 1094.

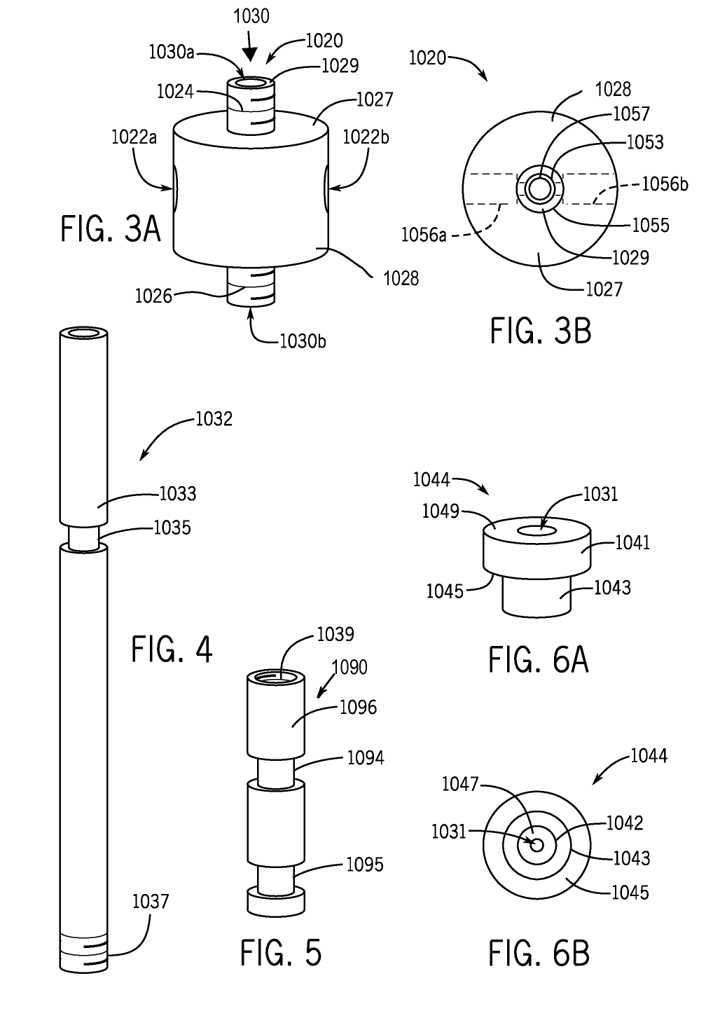

An elastomer tube 1098 may be positioned adjacent to the piston head 1090 at the connection between the piston head 1090 and the valve stem 1032. The valve stem 1032 may axially align with the cap 1044. The cap 1044 may center the first magnet assembly 1058 in axial alignment with the valve housing 1020. The first magnet assembly 1058 may include one or more magnets (e.g. 1058a-f). The valve stem 1032 and piston head 1090 may articulate relative to the first magnet assembly 1058. The valve stem 1032 may axially align with a second magnet assembly 1060 fixedly connected thereto. The second magnet assembly 1060 may include one or more magnets (e.g. 1060a-f). Any number of magnets may be used or any size of magnets may be used. Modifying the size, number, or strength of the magnets may adjust the force between the first magnet assembly 1058 and the second magnet assembly 1060. The magnets may be any shape and side and connect to the valve stem 1032 in any way. The magnets may have apertures. If larger than the valve stem 1032, the magnet apertures may utilize additional hardware (e.g. washers) to adapt the large apertures to the valve stem 1032. The connection may occur by restraining the second magnet assembly 1060 on the valve stem 1032 by placing clamps 1093, 1092 above and below the second magnet assembly 1060. The clamp 1092 below the second magnet assembly 1060 may be position on an elastomer tube 1091 located around a groove (See FIG. 3 groove 1035) cut in the valve stem 1032. The clamp 1093 above the magnet assembly 1060 may realize lower forces than the clamp 1092 below the magnet assembly 1060. As such, a clamp 1093 alone may be position above the second magnet assembly 1060 to keep it in place relative to the valve stem 1032. Although a similar configuration to the clamp, tube and groove (1092, 1091, and 1035 respectively) from below the second magnet assembly 1060 may be likewise applied above as well. Elastomer tubes 1091 and 1098 provide a cushion as the valves articulate since the elastomer tubes 1091 and 1098 contact the cap 1044 when the piston head 1090 articulates in one direction or the other. Elastomer tube 1098 limits the travel by contacting the cap 1044 in the upward direction. Elastomer tube 1091 limits the travel by contacting the cap 1044 in the downward direction.

In accordance with various embodiments, a liquid distribution channel 1023a may axially align with a male pipe coupling 22a. Likewise, a liquid distribution channel 1023b may axially align with a male pipe coupling 22b. These connections may be accomplished by any variety of hydraulic connections, including for example threaded fittings. The liquid distribution channel 1023a,b or conduit may be fluidly coupled with the outlet port 1022a,b. In one example, the channels 1023a,b may be defined by a polyethylene tubing, which may be bent, such as through use of a heat gun, into a variety of distribution patterns according to the needs of a particular user. It is envisioned that other conduits, such as stainless steel, rubber hose, pre-formed tubing, adjustable tubing, ball-and-socket piping, and the like may be used. In the various embodiments, the channels 1023a,b may extend transversely from the valve 1010 and then bend upwardly and substantially vertically, with the end of the channel 1023a,b generally above the valve 1010 so as to allow unimpeded liquid distribution from a sprinkler head such as those discussed in related embodiments.

FIG. 3A is an isometric view of an embodiment of a valve housing 1020. As discussed above, the valve 1010 includes a valve housing 1020. The valve housing 1020 may be any shape operable to flow a fluid through one or more channels. In various examples the valve housing 1020 may be an elongated cylindrical shape formed about a longitudinal axis. The valve housing 1020 may include a top surface 1029. The valve housing 1020 may include a longitudinal bore 1030. In various examples, the longitudinal bore 1030 may be formed along the longitudinal axis of the cylindrical shape. In various examples, the longitudinal bore 1030 may be any channel passing through the valve housing 1020 that is operable to receive the valve stem 1032 and/or the piston head 1090. The valve housing 1020 may include at least one outlet port 1022a. In various examples, the valve housing 1020 may include diametrically-opposing outlet ports 1022a, 1022b defined by walls 1056a, 1056b (shown in FIG. 3B). The outlet ports may be a transverse bore passing through the longitudinal bore 1030 in a substantially perpendicular orientation. In various embodiments the transverse bore may be at an angle to the longitudinal bore 1030. In various embodiments, the transverse bore may not extend linearly through but the bore defined by wall 1056a may be an angle to the bore defined by wall 1056b. In various embodiments, the valve housing 1020 may include any number of outlet ports 1022a,b required to facilitate a particular fluid distribution pattern. The outlet ports 1022a,b are located above the bottom threaded portion 1026 of the valve housing 1020. Generally, the outlet ports 1022 are perpendicular to the longitudinal bore 1030 and the sidewall 1028 and form an aperture there between. Each outlet port 1022a, 1022b may have any diameter suitable to connection with plumbing and/or hydraulic fixtures such as the male pipe coupling 22a, 22b. In various examples, each outlet port 1022a, 1022b may have diameter of suitable size to receive a barbed or threaded male coupling.

The valve housing 1020 may include a top portion 1024 and a bottom portion 1026. In various examples the top and bottom portions 1024, 1026 may be threaded. A sidewall 1028 may extend between the top portion 1024 and the bottom portion 1026. In various examples, the side wall 1028 may be larger in diameter than the top portion 1024 and/or the bottom portion 1026. The sidewall 1028 outer circumference and the top portion 1024 outer circumference may be connected by a flat surface 1027 forming a top to the sidewall 1028. The top portion 1024 and bottom portion 1026 may be operable to receive any mechanical fitting including, for example, hydraulic fittings. The top portion 1024 may be sized to receive the cap 1044. In various examples, the top portion 1024 may include a first set of threads that extend down a first distance from the top of the valve as shown in FIG. 3A and then a second set of threads that extend the remainder of the length of the top portion 1024. The first set of threads may be 1 inch NPT tapered threads and the second set of threads may be 1 inch NPT straight threads. A similar configuration may be applied to the bottom portion 1026 or in accordance with various examples the bottom portion may have a single thread set such as NPT tapered threads extending the length of the bottom portion 1026. The top portion and the bottom portion may extend the same length from the side wall 1028. Alternatively, the two portions 1024, 1026 may be different lengths. The length of bottom portion 1026 may be minimized to decrease the length that valve housing 1020 extends below the support (e.g. platform 1015), but still be sufficiently long to receive a fitting such as the end of fluid supply conduit 1012. The length of top portion 1024 on the other hand may be suitable to extend a portion of the distance through the first magnet assembly 1058 and receive the cap 1044 from the opposite side of the first magnet assembly 1058. The cap 1044 may be threaded onto the top portion 1024 and sandwich the first magnet assembly 1058 and/or platform 1015 there between.

As illustrated in FIG. 3A, the longitudinal cylindrical longitudinal bore 1030 extends through the valve housing 1020 between the top portion 1024 and the bottom portion 1026. The longitudinal bore 1030 is adapted to receive a valve stem 1032. The longitudinal bore 1030 may be comprised of two bores 1030a and 1030b. Stated another way, the longitudinal bore 1030 may have a first bore diameter 1030a and a second bore diameter 1030b. FIG. 3B is a top view of an embodiment of the valve housing 1020 showing a first internal wall 1053 and a second internal wall 1057. The first internal wall 1053 may define the first bore 1030a. The second internal wall 1057 may define the second bore 1030b. The first internal wall 1053 may have a larger diameter than the second internal wall 1057. The first bore 1030a (and the corresponding first internal wall 1053) may meet and transition 1055 to the second bore 1030b (and the corresponding second internal wall 1057) at the transition 1055. The transition 1055 may form a surface that connects the first diameter and the second diameter. In various embodiments the transition may be a surface at a 45 degree angle to an axis/plane that passes perpendicular to the longitudinal bore 1030. The valve housing 1020 is typically fabricated from a polymeric material having a low coefficient of friction, such as Teflon™.

FIG. 4 illustrates an isometric view of an embodiment of a valve stem 1032. The valve stem 1032 may include an elongated cylindrical body 1033. The valve stem 1032 may have a threaded end 1037 operable to engage a piston head 1090. Intermediately along the body 1033, the valve stem 1032 may include an annular groove 1035 operable to aid in positioning the second magnetic assembly 1060 above the groove 1035. For example, a portion of tubing 1091 may be positioned over the groove 1035 and secured in place within the groove with a clamp 1092 (e.g. Oetiker clamp). The tube 1091 and the clamp 1092 may then support the magnet assembly 1060 above the groove.

The valve stem 1032 may be fabricated from a rigid material that is resistant to corrosion from whatever fluid that is to be distributed from the valve 1010. In one example, the valve stem 1032 may be made of stainless steel. The surface of the valve stem 1032 may be typically smooth to reduce its coefficient of friction, which provides smooth movement of the valve stem 1032 within the longitudinal bore 1030 and/or within the cap 1044. The longitudinal bore 1030 may be an aperture with a diameter that is larger than the diameter of the valve stem 1032, which substantially reduces or prevents any contact between the valve stem 1032 and the longitudinal bore 1030.

FIG. 5 is an isometric view of an embodiment of a piston head 1090. The piston head 1090 may include an elongated cylindrical body 1096. On a first end, the piston head 1090 may have a threaded aperture 1039 operable to engage the threaded end 1037 of valve stem 1032. Intermediately along the body 1096, the piston head 1090 may include a first annular groove 1095 operable to position first seal 1050 proximate the end of the piston head which is distal to the threaded aperture 1039. In various examples, first seal 1050 may be an o-ring operable to seat and form a liquid tight seal within the second bore 1030b. It may be noted that other seals such as a u-cup type seal may also be applicable. Intermediately along the body 1096, the piston head 1090 may include a second annular groove 1094 operable to position the second seal 1052 proximate the threaded aperture 1039. In various examples, the second seal 1052 may be a U-Cup type seal operable to seat and form a liquid tight seal within the first bore 1030a. It may be noted that other seals such as an o-ring type seal may also be applicable. The first annular groove 1095 may be smaller in diameter than the second annular groove 1094. The decrease in diameter may be directly related and/or proportional to the decrease in size between the first bore 1030a and the second bore 1030b.

In accordance with various embodiments, the piston head 1090 and the valve stem 1032 are separate devices that are merely able to connect to one another. The two devices may have different material properties. In accordance with various embodiments, the piston head 1090 and the valve stem 1032 are one contiguous device manufactured together such as being machined out of one piece of stock material.

FIG. 6A is an isometric view of an embodiment of a cap 1044. The cap 1044 may include a bore 1031 which aligns with the longitudinal bore 1030 of valve housing 1020. The bore 1031 may extend through a cap upper surface 1049. A cap body 1041 may extend down from the upper cap surface 1049. A cap lower portion 1043 may extend down from cap body 1041. The cap body 1041 and cap lower portion 1043 may be different diameters. For example, the cap body 1041 may be larger in diameter than the cap lower portion 1043. A lower exterior surface 1045 may connect the cap body 1041 and the cap lower portion 1043. The lower exterior surface 1045 may be substantially parallel to the cap upper surface 1049. FIG. 6B is a top view of an embodiment of a cap 1044. The cap lower portion 1043 may be tubular aligned on the same axis of bore 1031. The cap lower portion 1043 may have an interior wall 1042 that defines the interior cavity of the tubular nature of the cap lower portion. Interior wall 1042 may be threaded and operable to receive the top portion of valve housing 1020, whereas the exterior surface of the lower cap portion 1043 may be operable to be inserted into the first magnetic assembly 1058. The exterior surface of the cap lower portion 1043 may restrain the first magnetic assembly 1058 by engaging with their inner surface. The cap 1044 may have an interior surface 1047 which surrounds the bore 1031 on the inside of interior wall 1042. Interior surface 1047 may be operable to engage the piston head 1090 on the end of valve stem 1032 and limiting the range of travel of the piston head 1090. This limit to the range of travel may prevent or limit the piston head 1090 from being pushed out of the longitudinal bore 1030 by the fluid pressure within the valve housing 1020. The valve stem 1032 may pass through bore 1031 which may be aligned with the longitudinal bore 1030. In various examples, at least one magnet (e.g. 10580 may be attached to the cap 1044, such as by a fastener (e.g. adhesive). Like the cap 1044, the first magnet assembly 1058 and the second magnet assembly 1060 define an aperture in alignment with the cap bore 1031 that allows the valve stem 1032 to pass there through.

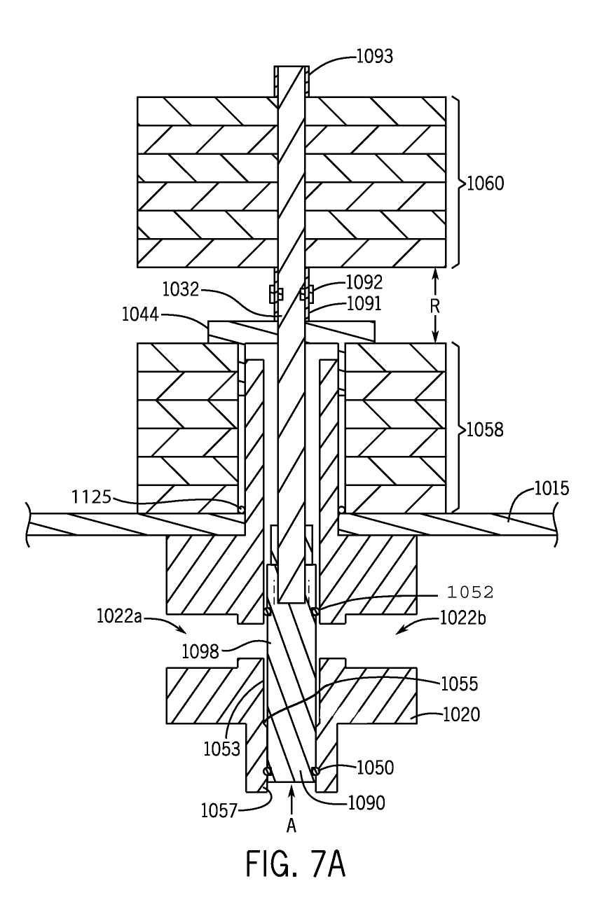

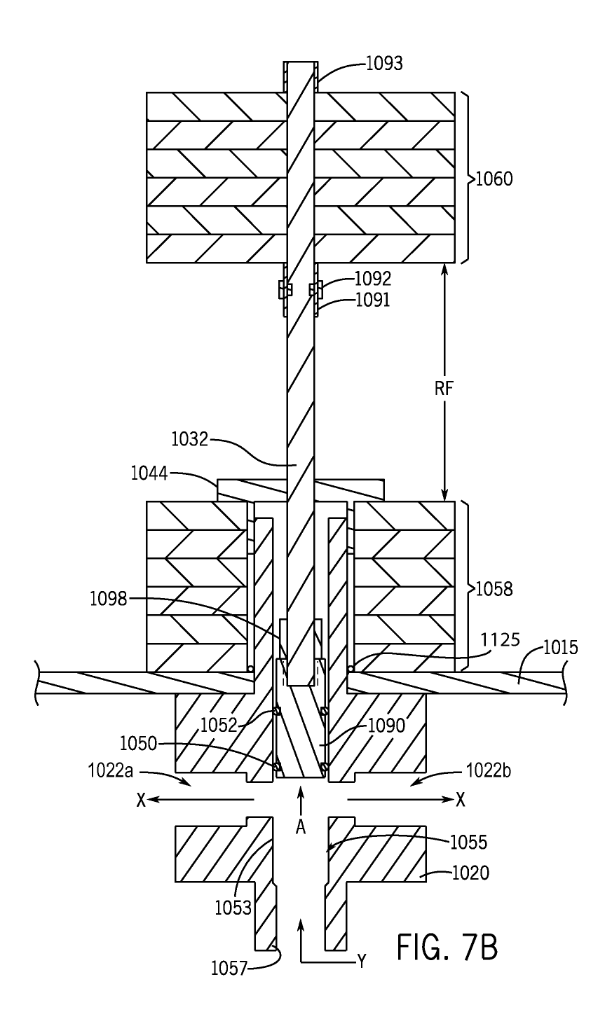

FIG. 7A illustrates a cross-sectional view of the pressure activated magnetic valve 1010 of FIG. 1 taken along line A-A illustrating the valve 1010 in the closed position. As shown, the valve stem 1032 may project upwardly through the valve housing 1020. The top portion of valve stem 1032 may pass through and/or be adjacent the top portion 1024 of the valve housing 1020. The lower portion of the valve stem 1032 is adjacent the bottom portion 1026 of the valve housing 1020. The piston head 1090 is connected to the threaded end 1037 of the valve stem 1032. The first seal 1050 is secured around the first annular groove 1095 on the piston head 1090. (In one example, the first seal 1050 may be a 50 durometer 0-ring with a high lubricity coating and/or a high lubricity Buna formulation). The first seal 1050 is positioned so that the first seal 1050 is located below the outlet ports 1022a,b when the valve stem 1032 is in the closed position as shown in FIG. 7A. The first seal 1050 is positioned between the piston head 1090 and the second internal wall 1057 of valve housing 1020. The first seal 1050 spans the gap between the outside diameter of the piston head 1090 and the inside diameter of the second internal wall 1057. The first seal 1050 prevents fluid from flowing through the valve 1010 until the retention force (R) is met or exceeded by the activation force (A). To do this, the first seal 1050 blocks the portion of the bore above the first seal 1050 from fluid located below the first seal 1050, to thereby prevent fluid from flowing through the valve 1010 until the A≧R. Since the first seal 1050 slides in the longitudinal bore 1030 with the piston head 1090, a lubricant such as SuperLube™ by Synco Chemical Corp., may be applied to the first seal 1050 to facilitate smooth movement in the longitudinal bore 1030 and to help break in the first seal 1050. Generally, the sealed or closed position of the valve 1010 (wherein water is not flowing through the outlet ports) is maintained while the retention force exceeds the pressure in the reservoir.

The second seal 1052 is secured around the second annular groove 1094 on the piston head 1090. The second seal 1052 is positioned so that the second seal 1052 is located above the outlet ports 1022a,b whether the valve stem 1032 is in the closed position as shown in FIG. 7A or in the open position as shown in FIG. 7B. The second seal 1052 is positioned between the piston head 1090 and the valve housing 1020 the first internal wall 1053. The second seal 1052 spans the gap between the outside diameter of the piston head 1090 and the inside diameter of the wall 1053. By spanning this gap, the second seal 1052 better limits the intrusion of liquid out of the top of valve housing 1020, which is generally an undesirable path for the liquid. As mentioned above, the second annular groove 1094 may be larger in diameter than the first annular groove 1095. Additionally, as noted above, the first bore 1030a is larger in diameter than the second bore 1030b. The effect is that, the second seal 1052 located over the second annular groove 1094 is forced into a larger external circumference by the larger diameter of the second annular groove 1094. Forcing the second seal 1052 into a slightly larger external circumference enables the second seal 1052 to better engage the larger diameter of the longitudinal bore 1030a. The first annular groove 1095 may be smaller in diameter than the second annular groove 1094. As such, the first seal 1050 fitted into first annular groove 1095 may have a smaller exterior circumference which better fits within the second bore 1030b.

FIG. 7B illustrates a cross-sectional view of the pressure activated magnetic valve 1010 of FIG. 1 taken along line A-A illustrating the valve 1010 in the open position. In this open position, the piston head 1090 is above the fluid outlets 1022a,b, allowing the fluid to flow in the direction X. In this position the A≧R causing the valve 1010 to open. The second seal 1052 maintains the same contact with first bore 1030a as it would in the valve closed position. The first seal 1050, which is located around the smaller diameter of the first annular groove 1095 is positioned within first bore 1030a (i.e. the larger bore diameter). In this position the first seal 1050 makes less contact with the first internal wall 1053 of first bore 1030a than with the second internal wall 1057 of the second bore 1030b, thus reducing the friction on the first seal 1050. By reducing the friction on the first seal 1050 due to the larger diameter first bore 1030a, wear is reduced prolonging the life of the first seal 1050. Sealing against liquids passing out of the top of the valve housing 1020 is still provided because the second seal 1052 is in similar contact with first bore 1030a preventing the bypass of liquids. Additionally, the pressure differential between the pressure required to open the vale 1010 (i.e. A>R) and the pressure required to close the valve (i.e. R>A) is narrowed, because the reduction in friction within the valve reduces the force requirements to open and close the valve. Stated another way, the fluid pressure holding the valve open does not have to be reduced as much, due to less friction, in order to close the valve once it is open.

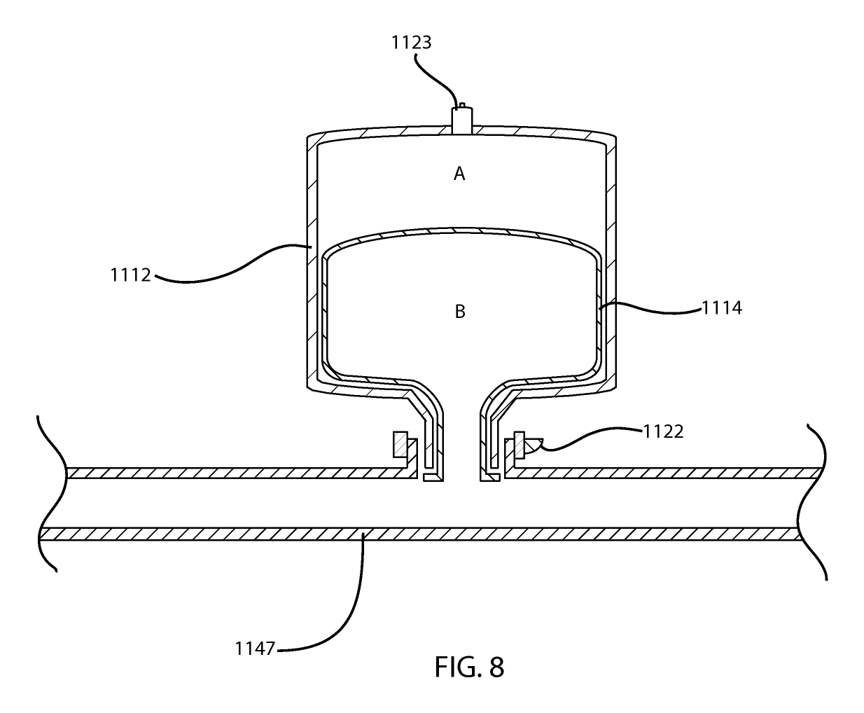

FIG. 8 illustrates a cross section of a reservoir 1112. An inlet valve allows fluid, such as water, to flow into the reservoir 1112 from a source of fluid, such as a standard garden hose fluidly connected with a domestic water tap. As discussed herein and in related embodiments, the liquid is prevented from flowing out of the outlet of the reservoir 1112 until a retention force (R) is met or exceeded by the pressure in the reservoir, which acts as an activation force (A) on the bottom of the valve stem 1032. In the open position the R is lessened due to the distance between the magnets and may be references as RF. In the first embodiment, a partially elastic bladder 1114 within reservoir 1112 expands volumetrically when pressurized by fluid B. When the valve 1010 is opened, the elastic walls of bladder 1114 contract and force the water contained therein into the longitudinal bore 1030 as the walls contract into their nominal position. The contraction of the walls of bladder 1114 is aided by the compression of a compressible fluid A (e.g. air) within the reservoir 1112. Accordingly, the reservoir 1112 contains a greater volume of water at the pressure when the valve opens than it holds at the pressure level at which the valve 1010 closes. It is generally the difference in these volumes that is expelled from the reservoir 1112 during each operational cycle of the valve 1010. If a substantially rigid reservoir 1112 were utilized, very little water, perhaps a negligible amount, would be expelled from the rigid reservoir 1112 before the pressure therein dropped below the level at which the valve 1010 would close, since liquids are incompressible fluids. In embodiments of the invention adapted for use with compressible gaseous fluids, a rigid reservoir 1112 can be used since the expansion of the gas would act to maintain pressure therein. Furthermore, a rigid reservoir 1112 can be utilized with a liquid, if a portion of the reservoir 1112 contains a gas or other compressible medium, which expands as the liquid contained therein is expelled. In various embodiments, a clamp 1122 may attached the reservoir 1112 to the fluid line 1147.

The reservoir 1112 may be positioned in an upright position such that as the bladder 1114 expands it is not biased against the side walls of the reservoir 1112 by gravity. Avoiding bias against the sidewalls may extend the life of the bladder 1114 by reducing constant friction against the side walls during the constant expansion and retraction of the bladder 1114 during cycling of the system. In various embodiments, the reservoir 1112 may include a valve. In various examples, the valve 1123 may be positioned at the highest point on the reservoir 1112. The valve 1123 may be a suitable valve to add air to the system. For example, the valve may be a Schrader valve which is operable to receive compressed air.

Although the present invention has been described with a certain degree of particularity, it is understood that the present disclosure has been made by way of example, and changes in detail or structure may be made without departing from the spirit of the invention as defined in the appended claims.

Many of the specific components utilized in the described embodiments are merely exemplary and other components may be substituted for them without deviating from the scope of the invention. For instance, the 0-ring seal can be replaced with any suitable type of sealing element that would prevent the fluid contained in the reservoir 1112 from flowing past it when the valve is in its closed position. Additionally, the materials that comprise the various components may vary. The valve housing which is made of Teflon™ in the embodiments described herein could be comprised of another polymeric material, such as ultra high-density polyethylene, or it could be comprised of a metallic material, such as brass. Likewise, the valve stem could be fabricated from a plastic or composite material instead of stainless steel.

The valve is described above primarily in terms of a sprinkler system for the irrigation of lawns, plants, and/or crops. In addition to serving this purpose, alternative embodiments of the sprinkler system may be utilized to scare away critters and varmints that might disturb plants and crops in the area surrounding the sprinkler. It can be appreciated that the noise emanating from the valve as it opens and closes may be relatively loud depending on how the valve is designed and that this noise can be used to startle animals. If additional noise is desired, other noisemakers, such as bells, may be affixed to the valve stem to create additional noise as the valve is actuated. In other embodiments, the valve may be used for purposes unrelated to sprinkler systems or irrigation. It is contemplated that the valve may be utilized in any number of applications where a periodic controlled release of fluid is required from a pressurized source. The fluid may be either liquid or gaseous or a combination thereof.

In one sense, the present invention is a valve for releasing a fluid from a pressurized source starting when the pressure in the reservoir 1112 reaches a first critical level and ending when the pressure of the fluid from its source drops below the critical level. The valve assemblies described above provide exemplary means for accomplishing the periodic release of a fluid from a pressurized source utilizing forces provided by weights and magnets. Other mechanisms, such as springs, electromagnetic, and the like, in lieu of magnets and weights are contemplated for providing a valve with similar functionality. The present invention although described in an upright position wherein the valve stem moves up and down in the barrel may also be oriented in other positions. The principles described herein will work in a similar manner. The magnetic force, however, might require adjustment to account for differences in gravitational effect. The present invention is useful where any periodic liquid dispersal is desired.

We claim:

1. A device for the intermittent dispersal of a fluid, the device comprising:
a housing with an inlet, to receive a fluid placed under increasing pressure, and having an outlet to disperse the fluid, wherein the housing includes a longitudinal bore extending through the housing and intersecting a transverse bore forming the outlet, the longitudinal bore having a first diameter and a second diameter in fluid communication with the inlet;
a piston head at least partially contained within the longitudinal bore of the housing, the piston head being movable (i) from a closed position to an open position when the fluid pressure equals or exceeds a first pressure level, and (ii) from an open position to a closed position when the pressure is less than or equal to a second pressure level, the second pressure level being lower than the first pressure level; wherein the piston head includes a first seal which obstructs the flow of the fluid from the inlet to the outlet in response to the piston head being in the closed position and permits the flow of fluid from the inlet to the outlet in response to the piston head being in the open position; and wherein the first seal contacts the first bore diameter in the closed position and moves out of the first bore diameter in the open position.

2. The device of claim 1, wherein the first diameter of the longitudinal bore is smaller than the second diameter of the longitudinal bore.

3. The device of claim 1, wherein the piston head further includes a second seal in contact with the second diameter of the longitudinal bore.

4. The device of claim 2, wherein the second seal maintains contact with the second diameter of the longitudinal bore in both the open position and closed position thereby obstructing fluid from flowing out of the longitudinal bore.

5. The device of claim 1, wherein the first seal has less contact with the longitudinal bore in the open position than in the closed position thereby reducing friction between the first seal and the longitudinal bore in the open position.

6. The device of claim 2, wherein the first diameter of the longitudinal bore and the second diameter of the longitudinal bore meet at a transition located between the inlet and the transverse bore.

7. The device of claim 6, wherein the transition is a surface connecting a wall defining the first diameter of the longitudinal bore and a wall defining the second diameter of the longitudinal bore and the transition surface is approximately 45 degrees from a plane perpendicular to the longitudinal bore.

8. The device of claim 3, wherein the first seal is located within a first groove around the piston head with the first groove having a first diameter.

9. The device of claim 8, wherein the second seal is located within a second groove around the piston head with the second groove having a second diameter.

10. The device of claim 9, wherein the second groove is larger in diameter than the first groove thereby causing an outer circumference of the second seal to extend farther from the axis of the piston head than an outer circumference of the first seal causing the second seal to have tighter fit in the second diameter of the longitudinal bore than the fit of the first seal.

11. The device of claim 1, further comprising a valve stem connected to the piston head and extending out of the housing opposite the inlet and along the longitudinal bore, wherein the valve stem passes through a first magnet assembly and connecting to a second magnet assembly such that the second magnet assembly moves in relation to the valve stem which in turn moves the piston head.

12. The device of claim 11, further comprising a cap which attaches to a top portion of the housing located opposite the inlet, wherein the first magnet assembly is sandwiched between the cap and the housing.

13. The device of claim 12, wherein the attraction between the first magnet assembly and the second magnet assembly forms at least a portion of a retention force to hold the piston head in the closed position against the fluid under increasing pressure, wherein the piston head moves toward the open position when the retention force is met.

14. The device of claim 13, further comprising a reservoir in fluid communication with the inlet that is adapted to contain a compressible medium and to receive a fluid providing an increasing pressure in the reservoir, wherein the reservoir supplies the fluid placed under increasing pressure received by the inlet, wherein the compressible medium and the fluid are separated by an expandable bladder which limits the fluid from absorbing the compressible medium.

15. The device of claim 14, wherein the reservoir is a tank positioned vertically such that the bladder uniformly expands within the tank without being substantially biased in one direction due to gravity.

16. A device for the intermittent dispersal of a fluid, the device comprising:
a housing with an inlet, to receive a fluid placed under increasing pressure, and having an outlet to disperse the fluid, wherein the housing includes a longitudinal bore extending through the housing and intersecting a transverse bore forming the outlet;
a piston head at least partially contained within the longitudinal bore of the housing, the piston head being movable (i) from a closed position to an open position when the fluid pressure equals or exceeds a first pressure level, and (ii) from an open position to a closed position when the pressure is less than or equal to a second pressure level, the second pressure level being lower than the first pressure level; wherein the piston head includes a first seal and a second seal, wherein the first seal is seated more tightly in the longitudinal bore in response to the piston head being in the closed position than compared to the seating of the first seal in the longitudinal bore in response to the piston head being in the open position, and wherein the second seal maintains substantially the same fit within the longitudinal bore regardless of whether the piston head is in the closed position or the open position.

17. The device of claim 16, wherein the longitudinal bore includes a first diameter and a second diameter with the first diameter being smaller than the second diameter, wherein the first seal obstructs the flow of the fluid from the inlet to the outlet in response to the piston head being in the closed position and permits the flow of fluid from the inlet to the outlet in response to the piston being in the open position; wherein the first seal contacts the first bore diameter in the closed position and moves out of the first bore diameter in the open position having less contact with the longitudinal bore in the open position than in the closed position, wherein the piston head further includes a second seal in contact with the second diameter of the longitudinal bore and the second seal maintains contact with the second diameter of the longitudinal bore in both the open position and closed position thereby obstructing fluid from flowing out of the longitudinal bore.

18. The device of claim 17, wherein the first diameter of the longitudinal bore and the second diameter of the longitudinal bore meet at a transition located between the inlet and the transverse bore, the transition being a surface connecting a wall defining the first diameter of the longitudinal bore and a wall defining the second diameter of the longitudinal bore and the transition surface is approximately 45 degrees from a plane perpendicular to the longitudinal bore.

19. The device of claim 16, wherein the first seal is located within a first groove around the piston head and the second seal is located within a second groove around the piston head with the first groove having a first diameter and the second groove having a second diameter.

20. The device of claim 19, wherein the second groove is larger in diameter than the first groove thereby causing an outer circumference of the second seal to extend farther from the axis of the piston head than an outer circumference of the first seal causing the second seal to have tighter fit in the second diameter of the longitudinal bore than the fit of the first seal within the second diameter of the longitudinal bore.
